(19) United States
(12) Patent Application Publication
(10) Pub. No.: US 2022/0124504 A1
(43) Pub. Date: Apr. 21, 2022

(54) METHOD FOR VALIDATING MAN-IN-THE-MIDDLE ATTACK FOR CELLULAR CONTROL PLANE PROTOCOLS AND THE SYSTEM THEREOF

(71) Applicant: Korea Advanced Institute of Science and Technology, Daejeon (KR)

(72) Inventors: Yongdae Kim, Daejeon (KR); Hongil Kim, Daejeon (KR); Yeong Bin Hwang, Daejeon (KR)

(21) Appl. No.: 17/451,222

(22) Filed: Oct. 18, 2021

(30) Foreign Application Priority Data
Oct. 16, 2020 (KR) 10-2020-0133928
Sep. 27, 2021 (KR) 10-2021-0126824

(51) Int. Cl. H04W 12/121

(52) U.S. Cl. CPC H04W 12/121

(57) ABSTRACT

Disclosed are a method of validating a man-in-the-middle attack on a cellular control plane protocol and a system thereof, which can diagnose the vulnerability of a man-in-the-middle attack in a mobile communication network through automated test execution and security threat detection by generating test cases. The method includes generating a test case defining an operation of the control plane protocol, performing a man-in-the-middle attack scenario by the test case in conjunction with mobile communication equipment and user equipment by using the test case, and determining whether there is a security threat to the user equipment or a network by analyzing a control plane message generated by performing the scenario of the test case.

### CROSS-REFERENCE TO RELATED APPLICATIONS

A claim for priority under 35 U.S.C. § 119 is made to Korean Patent Application No. 10-2021-0126824 filed on Sep. 27, 2021, in the Korean Intellectual Property Office, the entire contents of which are hereby incorporated by reference.

### BACKGROUND

Embodiments of the inventive concept described herein relate to a method of validating a man-in-the-middle attack on a cellular control plane protocol and a system thereof, and more particularly, relate to a technique for diagnosing the vulnerability of a man-in-the-middle attack in a mobile communication network through automated test execution by generating test cases and security threat detection.

In a mobile communication network, a control plane protocol refers to a control-related procedure performed by user equipment to normally use a wireless service provided by a mobile communication network, and performs security functions such as mutual authentication, communication encryption, and integrity protection so that only authorized users can use the service.

In order to provide a safe and reliable service as well as a user's quality of experience in a mobile communication network, it is very important to check the correct operation and security of the control plane procedure. Therefore, it is a very important technology for mobile communication equipment manufacturers and operators to detect abnormal operations and security threats that occur during the control plane procedure, and to find and solve the cause.

In this case, the specific control plane procedure and operation of the mobile communication network is defined by a standard organization called 3rd generation partnership project (3GPP). However, the standard describing the control plane operation is written based on a vast amount of natural language, and various implementations are possible according to the operation policy of a manufacturer or communication network operator. The 3GPP standard defines a test case and execution method for a conformance test that confirms whether a mobile communication user equipment operates according to the standard. Accordingly, the manufacturer may validate whether the developed user equipment can receive a normal service in various situations from a commercial mobile communication network through the conformance test. However, because the conformance test case does not consider an attacker who poses a security threat between network communications, the validation process for this is not defined in the standard.

Among mobile communication network security threats, a man-in-the-middle attack is an attack technique that intercepts communication between a user equipment and a mobile communication base station to eavesdrop on or manipulate the contents. Although the user equipment thinks it is communicating with the normal network, it is actually connected to a man in the middle, and the man in the middle receives a message from the user equipment or network, steals the necessary information, or performs an attack by transferring it as it is or by altering it.

There is no way to detect a man-in-the-middle attack in the current mobile communication standard due to the characteristics of wireless communication between the user equipment and the base station. However, mutual authentication, control plane and user data encryption, and control plane message integrity protection are applied to minimize security threats caused by man-in-the-middle attacks. However, in the standard, various implementation and setting options are defined in order to support various usage environments such as industrial IoT, V2X, and public safety networks and suitable user equipment and network equipment, and manufacturers and operators are supposed to implement them according to the environment. In this case, it is entirely up to the manufacturer to validate in which cases it can be vulnerable to a man-in-the-middle attack.

For this reason, there are various operation implementation and operation options in the standard of the control plane protocol, and it is difficult to diagnose the effectiveness of the man-in-the-middle attack, the attack effect, and the like in each case through the formal analysis of the standard technical document. In addition, a weakness in the control plane protocol that enables a man-in-the-middle attack may occur when the manufacturer implementing mobile communication equipment and user equipment incorrectly implements it or due to incorrect network configuration policy and settings of the communication operator. Therefore, there is a need to provide a dynamic analysis method that can diagnose the presence of potential security threats due to man-in-the-middle attacks for all kinds of implementation and setting options.

### SUMMARY

Embodiments of the inventive concept, which propose a method of dynamically detecting a part that may be vulnerable to a man-in-the-middle attack during various implementation or operation policy settings of user equipment and networks in a control plane protocol communication process, provides a method of diagnosing whether there is a security threat to a user equipment or network by analyzing control plane message information generated when a test case defining a control plane protocol procedure according to each implementation and operation policy is generated and the corresponding test case is performed.

According to an exemplary embodiment, a method of validating a man-in-the-middle attack on a cellular control plane protocol includes generating a test case defining an operation of the control plane protocol, performing a man-in-the-middle attack scenario by the test case in conjunction with mobile communication equipment and user equipment by using the test case, and determining whether there is a security threat to the user equipment or a network by analyzing a control plane message generated by performing the scenario of the test case.

The generating of the test case may include generating the test case defining a procedure and the operation of the control plane protocol according to each implementation and operation policy, and the test case may include a number, a direction, a name, a transmission scheme and content of a communication message between the user equipment and a base station.

The performing of the man-in-the-middle attack scenario may include configuring a scenario form of the man-in-the-middle attack by the test case, and executing an initial setting according to an attack environment of the test case.

The performing of the man-in-the-middle attack scenario may include performing an operation defined in each step of the test case for each message received from the user equipment or the network when the test case is executed, and determining whether the message received from the user equipment or the network corresponds to the scenario defined in the test case.

The determining of the security threat may include continuing to a next step when the message corresponds to the scenario defined in the test case, and analyzing the security threat when all the procedures of the scenario are completed.

The determining of the security threat may include determining that implementation and setting of the user equipment or network are not vulnerable to the man-in-the-middle attack to be tested when the message does not correspond to the scenario defined in the test case.

The determining of the security threat includes analyzing the control plane message including a response and state change information of the control plane received in the performing of the man-in-the-middle attack scenario to detect whether there is the security threat including eavesdropping, user privacy, and denial of service when all procedures of the scenario are performed through the performing of the man-in-the-middle attack scenario.

According to an exemplary embodiment, a system of validating a man-in-the-middle attack on a cellular control plane protocol includes a generation unit that generates a test case defining an operation of the control plane protocol, and an attack detection unit that determines whether there is a security threat to user equipment or a network by analyzing a control plane message generated by performing a man-in-the-middle attack scenario by the test case in conjunction with mobile communication equipment and the user equipment by using the test case.

The generation unit may generate the test cases defining a procedure and the operation of the control plane protocol according to each implementation and operation policy, and the test case may include a number, a direction, a name, a transmission scheme and content of a communication message between the user equipment and a base station.

The attack detection unit may include a scenario performing unit that performs the man-in-the-middle attack scenario, and an attack determination unit that determines whether the security threat exists. The scenario performing unit may configure a scenario form of the man-in-the-middle attack by the test case and execute an initial setting according to an attack environment of the test case.

The scenario performing unit may perform an operation defined in each step of the test case for each message received from the user equipment or the network when the test case is executed, and determine whether the message received from the user equipment or the network corresponds to the scenario defined in the test case.

The attack detection unit may continue to a next step when the message corresponds to the scenario defined in the test case, and analyze the security threat when all the procedures of the scenario are completed.

The attack detection unit may determine that implementation and setting of the user equipment or network are not vulnerable to the man-in-the-middle attack to be tested when the message does not correspond to the scenario defined in the test case.

The attack detection unit may analyze the control plane message including a response and state change information of the control plane received in the scenario performing unit to detect whether there is the security threat including eavesdropping, user privacy, and denial of service when all procedures of the scenario are performed through the scenario performing unit.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a flowchart illustrating a method of validating a man-in-the-middle attack according to an embodiment of the inventive concept;

FIG. 2 is a view illustrating an example of a test case according to an embodiment of the inventive concept;

FIG. 3 is a diagram illustrating the configuration of a man-in-the-middle attack validation technique according to an embodiment of the inventive concept;

FIG. 4 is a view illustrating an example of performing and detecting a man-in-the-middle attack test according to an embodiment of the inventive concept; and

FIG. 5 is a block diagram illustrating a detailed configuration of a man-in-the-middle attack validation system according to an embodiment of the inventive concept.

### DETAILED DESCRIPTION

Advantages and features of embodiments of the inventive concept, and method for achieving thereof will be apparent with reference to the accompanying drawings and detailed description that follows. But, it should be understood that the inventive concept is not limited to the following embodiments and may be embodied in different ways, and that the embodiments are given to provide complete disclosure of the inventive concept and to provide thorough understanding of the inventive concept to those skilled in the art, and the scope of the inventive concept is limited only by the accompanying claims and equivalents thereof.

The terms used in the present specification are provided to describe embodiments, not intended to limit it. In the present specification, singular forms are intended to include plural forms unless the context clearly indicates otherwise. It will be further understood that the terms “comprises,” and/or “comprising,” used herein, specify the presence of stated elements, but do not preclude the presence or addition of one or more other elements.

Unless otherwise defined, all terms used herein (including technical or scientific terms) have the same meanings as those generally understood by those skilled in the art to which the inventive concept pertains. Such terms as those defined in a generally used dictionary are not to be interpreted as having ideal or excessively formal meanings unless defined clearly and specifically.

Hereinafter, exemplary embodiments of the inventive concept will be described in detail with reference to the accompanying drawings. The same reference numerals are used for the same components in the drawings, and duplicate descriptions of the same components are omitted.

Embodiments of the inventive concept have a gist of dynamically detecting and validating a part that may be vulnerable to a man-in-the-middle attack during various implementation or operation policy settings of user equipment (UE) and a network in the control plane protocol communication process.

The user equipment is a device that is connected to a telephone network or an Internet network through a base station and a backhaul network to use a voice call or a wireless network. For example, the user equipment includes all smart devices, such as smart phones, tablet PCs, and smart watches, and the like, which can use voice calls or wireless networks, and is a concept including a notebook, a laptop computer, a PDA, and the like in addition to a smart device. The user equipment may transmit and receive voice information or data to and from another device (e.g., a portal server, other user equipment, or the like) by connecting a session with the telephone network or the Internet network through the base station and the backhaul network, so that the user equipment may use a voice call or a wireless network.

In addition, the user equipment receives a control plane message on various services (e.g., location check, user equipment authentication, call connection or radio resource connection, and the like) by using a voice call or a wireless network. The user equipment receives a control plane message on various services from a communication company that provides voice calls or wireless networks, and operates or determines according to the received control plane message. Thereafter, the user equipment transmits the operation result or determination result according to the control plane message to the telephone network or the Internet network, so that the communication company may check the operation result or determination result of the user equipment according to the transmission of the control plane message.

Furthermore, the base station exists between the user equipment and the backhaul network, and transmits voice information or data between the user equipment and the telephone network or the Internet network. The base station may be implemented as a NodeB when the network is implemented with 3G mobile communication, or implemented as an eNodeB when the network is implemented with 4G mobile communication.

The backhaul network connects the base station and the telephone network or the Internet network to transmit and receive data or control plane messages. The backhaul network may include various configurations according to the implementation form of the network. For example, when the network is implemented with 3G mobile communication, the backhaul network includes a configuration such as a mobile switching center (MSC), a serving GPRS support node (SGSN), a gateway GPRS support node (GGSN), or the like and transmits/receives data of a data plane and messages of a control plane, such as voice information or wireless network, between a communication company and user equipment through a telephone network or an Internet network. Meanwhile, when the network is implemented with 4G mobile communication, the backhaul network includes a mobility management entity (MME), a serving gateway (S-GW), a packet data network gateway (PGW), or a home subscriber server (HSS). As described above, the backhaul network is implemented by including a configuration for transmitting and receiving data or control plane messages according to the form in which the network is implemented. In the future, even when a new network (e.g., 5G mobile communication or a later generation mobile communication) appears due to the development of technology, the backhaul network may be implemented by including a configuration for transmitting and receiving data or control plane messages in the network.

A method of validating a man-in-the-middle attack on a cellular control plane protocol and a system thereof according to an embodiment of the inventive concept uses the generated test case to analyze the control plane message generated as a man-in-the-middle attack scenario is performed, and whether there is a security threat to the user equipment or network.

Accordingly, the inventive concept may provide a mobile communication network standard technology preemption effect. Technical Specification Group Service and System Aspects (TSG SA WG3) of 3GPP, which is a mobile communication network technology standards organization, is currently actively discussing to recognize various security threats that may occur due to man-in-the-middle attacks in 5G networks and to prepare countermeasures. In particular, various manufacturers have proposed different countermeasures and trying to standardize them. Therefore, by utilizing the technology of the inventive concept, manufacturers may preemptively diagnose security threat scenarios that may occur in various implementation and operation setting processes, and may propose appropriate countermeasures as standard technologies. In addition, recent 3GPP defines test cases and execution methods for validating the security functions of network equipment such as SCAS and NESAS. However, since the technology for the control plane protocol test case and function validation method considering the man-in-the-middle attacker is not included in the current standard, the technology of the inventive concept may be adopted as the standard technology of 3GPP in the future, and thus, have the effect of preempting the standard technology.

In addition, the inventive concept may enhance competitiveness in the mobile communication network equipment industry. The mobile communication network is expected to be utilized in various industries ranging from data communication and telephony to public safety, industrial Internet of Things (IoT), and vehicle to everything (V2X) communication. In particular, as a mobile communication network is introduced to services related to user safety, security accidents and performance problems in the mobile communication network may directly affect user safety. In addition, a security accident caused by an incorrect operation policy in the mobile communication network equipment may lead to economic loss not only for a telecommunication operator but also for an equipment manufacturer having the problem. Therefore, by applying the man-in-the-middle attack validation technology of the inventive concept to equipment developed before the system application stage, it is possible to detect potential threats in advance and prepare countermeasures, so that the inventive concept may prevent economic loss and use improved security technology as a competitive advantage compared to other equipment.

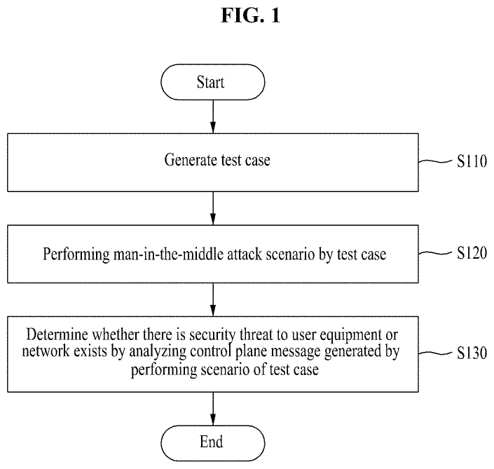

Hereinafter, the inventive concept will be described in more detail with reference to FIGS. 1 to 5.

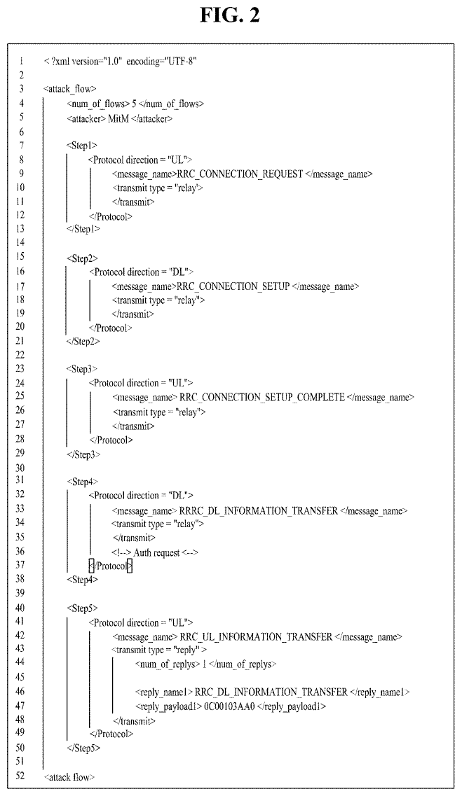

FIG. 1 is a flowchart illustrating a method of validating a man-in-the-middle attack according to an embodiment of the inventive concept. FIG. 2 is a view illustrating an example of a test case according to an embodiment of the inventive concept.

Referring to FIG. 1, in operation S110, a method of validating a man-in-the-middle attack according to an embodiment of the inventive concept generates test cases defining the operation of a control plane protocol.

In operation S110, a test case defining the procedure and operation of the control plane protocol according to each implementation and operation policy may be generated. In this case, the test case may include the number (num of flows) of communication messages between user equipment and a base station, a direction (Protocol direction), a name (message_name), a transmission type (transmit type), and content (message_payload). Referring to FIG. 2, the number (num of flows) indicates the total number of messages generated in a man-in-the-middle attack scenario to be performed. Therefore, it has “Step” as many as “num of flows” value, and it defines specifically which message is transmitted in each “Step”. First, the direction (protocol direction) has a value of UL or DL, UL means an uplink message transmitted from the user equipment to the network, and DL means a downlink message transmitted from the network to the user equipment. Next, the control plane protocol message name is defined in the name (message_name). This may be a specific message of L3 protocol (NAS, RRC) or L2 protocol (MAC, PDCP, RLC) depending on the type of man-in-the-middle attack to be performed. The transmission type (transmit type) refers to a method in which the man-in-the-middle attacker (Controller 400) on a test execution module processes the message transmitted from the user equipment or the network, and has a total of four methods.

First, in the case of “relay”, the message received by the man-in-the-middle attacker (Controller, 400) is transmitted without modification. For example, when a downlink message is received from the network, it is transmitted to the user equipment as it is. Second, in the case of “temper”, all or a part of the received message is replaced with the content defined in the content (message_payload) and transmitted. Third, in the case of “reply”, the content defined in “message_payload” is transmitted to the transmission end as a response without forwarding the received message. For example, when message “NAS Attach Request” is received from the user equipment, the message “NAS Attach Request” is sent back to the user equipment according to the “message_payload”. Finally, in the case of “drop”, the received message is not processed and any operations are not performed. The example of the test case illustrated in FIG. 2 is written in XML, and may be written in other data exchange languages according to the above-mentioned rule.

Thereafter, in operations S120 and S130, a method of validating a man-in-the-middle attack on a cellular control plane protocol according to an embodiment of the inventive concept performs a man-in-the-middle attack scenario by a generated test case in conjunction with mobile communication equipment and user equipment by using the test case, and determines whether there is a security threat to the user equipment or the network by analyzing the control plane message generated by performing the scenario of the test case.

In operation S120, a scenario form of the man-in-the-middle attack by the test case may be configured, and an initial setting according to an attack environment of the test case may be executed.

In addition, in operation S120, when the test case is executed, an operation defined in each step of the test case may be performed for each message received from the user equipment or the network, and it may be determined whether the message received from the user equipment or the network corresponds to the scenario defined in the test case.

As an example, when the message received from the user equipment or network in operation S120 is a message that does not correspond to the scenario defined in the test case, it may be determined in operation S130 that the implementation and setting of the user equipment or network is not vulnerable to the man-in-the-middle attack.

As another example, when the message received from the user equipment or network in operation S120 is a message that corresponds to the scenario defined in the test case, operations after S130 may be continued, and when all procedures of the scenario are performed, the control plane message including a response and state change information of the control plane received in operation S120 may be analyzed to detect whether there is a security threat including eavesdropping, user privacy, and denial of service.

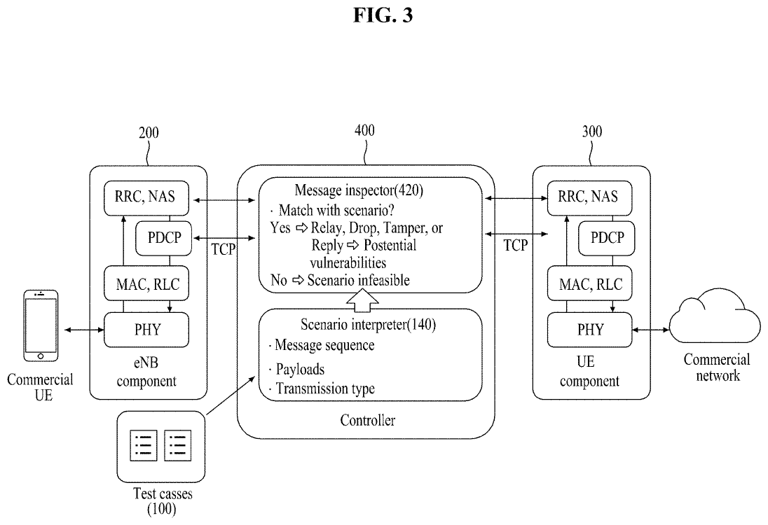

FIG. 3 is a diagram illustrating the configuration of a man-in-the-middle attack validation technique according to an embodiment of the inventive concept.

The man-in-the-middle attack validation technology according to an embodiment of the inventive concept includes a test case generation module and a man-in-the-middle attack test execution and security threat detection module.

The test case generation module performs a test case consisting of the number, direction, name, transmission method and content of messages exchanged between the user equipment and the base station. The man-in-the-middle attack test and security threat detection module performs the test case scenario by interworking with commercial mobile communication equipment and user equipment by using the generated test case, and analyzes the control plane message of the control plane response and state change information received in the above-mentioned process, thereby detecting whether there are security threats such as eavesdropping, user privacy, and denial of service.

As shown in FIG. 3, the man-in-the-middle attack validation technique according to an embodiment of the inventive concept as described above includes a controller 400, an eNB component 200, and an UE component 300.

The controller 400 first receives test cases 100 written in a scenario interpreter 410 as an input, configures the test cases in the form of a man-in-the-middle attack scenario, and executes the initial settings according to the attack environment of the test case. For example, in the case of tempering or relaying a message exchanged between the UE and the network, both the eNB component 200 and the UE component 300 must be interlocked, and in addition, in the case of a test case consisting of only reply or drop, only one component 200 or 300 may be executed as needed.

When the test case 100 is executed, a message inspector 420 may perform the operation defined in each step of the test case for each message received from the UE or the network. In this case, it is first determined whether the message received at the UE or the network corresponds to the scenario defined in the test case. When the message received at the UE or network corresponds to the scenario defined in the test case, a next step is continued. When all the procedures of the scenario have been completely performed, security threats that may occur at that time are analyzed. For example, user information contained in some messages is leaked due to the lack of encryption in network settings, resulting in user privacy issues, or eavesdropping is possible due to a problem that is not properly inspected in implementation in the process of integrity protection mutual authentication, and the like. It is determined whether there is a security threat such as abnormal use of the service of a normal user, and the like.

To the contrary, when a message is received that does not correspond to the defined scenario during test execution, it is determined that the implementation and setting of a commercial UE or network is not vulnerable to a man-in-the-middle attack to be tested.

The eNB component 200 and the UE component 300 perform wireless communication with a commercial UE and a commercial network, respectively. For example, the eNB component 200 is first set to be the same as a base station of a commercial network and the UE determines that it is a commercial base station to induce a connection attempt. In this case, when the control plane message is received from the UE, the message content of a specific protocol is transmitted to the controller 400 according to a scenario to be performed. According to an embodiment, when the controller 400 performs the relay, the corresponding message is transmitted to the UE component 300, and the UE component 300 is wirelessly connected to a commercial network with the same settings as the UE, such that the message received from the controller 400 is transmitted as it is. In this case, the UE and the eNB component 200 communicate with the controller 400 through a general wired Internet protocol (IP).

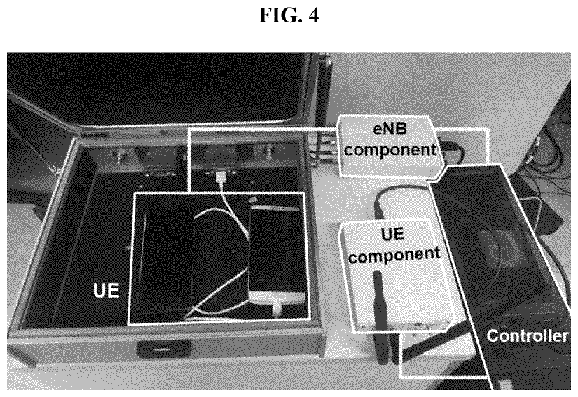

FIG. 4 is a view illustrating an example of performing and detecting a man-in-the-middle attack test according to an embodiment of the inventive concept.

FIG. 4 illustrates an example of implementing and installing the man-in-the-middle attack validation technology according to an embodiment of the inventive concept by using actual equipment, which may use USRP B210 which is software defined radio equipment, for wireless communication with UE and a network.

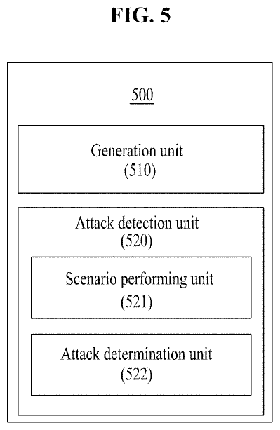

FIG. 5 is a block diagram illustrating a detailed configuration of a man-in-the-middle attack validation system according to an embodiment of the inventive concept.

Referring to FIG. 5, a man-in-the-middle attack validation system according to an embodiment of the inventive concept generates a test case, and diagnoses the vulnerability of man-in-the-middle attacks in a mobile communication network by automatically performing tests and detecting security threats.

To this end, a man-in-the-middle attack validation system 500 according to an embodiment of the inventive concept includes a generation unit 510 and an attack detection unit 520.

The generation unit 510 generates test cases defining the operation of the control plane protocol.

The generation unit 510 may generate a test case defining the procedure and operation of the control plane protocol according to each implementation and operation policy. In this case, the test case may be composed of the number of communication messages between the terminal and the base station (num_of_flows), the direction (Protocol direction), the name (message_name), the transmission method (transmit_type), and the content (message_payload). Referring to FIG. 2, the number (num_of_flows) indicates the total number of messages generated in a man-in-the-middle attack scenario to be performed. Therefore, it has “Step” as many as “num_of_flows” value, and it defines specifically which message is transmitted in each “Step”. First, the direction (protocol direction) has a value of UL or DL, UL means an uplink message transmitted from the user equipment to the network, and DL means a downlink message transmitted from the network to the user equipment. Next, the control plane protocol message name is defined in the name (message_name). This may be a specific message of L3 protocol (NAS, RRC) or L2 protocol (MAC, PDCP, RLC) depending on the type of man-in-the-middle attack to be performed. The transmission type (transmit_type) refers to a method in which the man-in-the-middle attacker (Controller 400) on a test execution module processes the message transmitted from the user equipment or the network, and has a total of four methods.

First, in the case of “relay”, the message received by the man-in-the-middle attacker (controller 400) is transmitted without modification. For example, when a downlink message is received from the network, it is transmitted to the user equipment as it is. Second, in the case of “temper”, all or a part of the received message is replaced with the content defined in the content (message_payload) and transmitted. Third, in the case of “reply”, the content defined in “message_payload” is transmitted to the transmission end as a response without forwarding the received message. For example, when message “NAS Attach Request” is received from the user equipment, the message “NAS Attach Request” is sent back to the user equipment according to the “message_payload”. Finally, in the case of “drop”, the received message is not processed and any operations are not performed.

Thereafter, the attack detection unit 520 of the man-in-the-middle attack validation system 500 according to an embodiment of the inventive concept performs a man-in-the-middle attack scenario by a generated test case in conjunction with mobile communication equipment and user equipment by using the test case, and determines whether there is a security threat to the user equipment or the network by analyzing the control plane message generated by performing the scenario of the test case. In this case, the attack detection unit 520 may include a scenario performing unit 521 for performing a man-in-the-middle attack scenario and an attack determination unit 522 for determining whether there is a security threat.

The scenario performing unit 521 may configure a scenario form of the man-in-the-middle attack by the test case, and execute an initial setting according to an attack environment of the test case.

In addition, when the test case is executed, the scenario performing unit 521 may perform an operation defined in each step of the test case for each message received from the user equipment or the network, and may determine whether the message received from the user equipment or the network corresponds to the scenario defined in the test case.

As an example, when the message received from the user equipment or network by the scenario performing unit 521 is a message that does not correspond to the scenario defined in the test case, the attack determination unit 522 may determine that the implementation and setting of the user equipment or network is not vulnerable to the man-in-the-middle attack.

As another example, when the message received from the user equipment or network by the scenario performing unit 521 is a message that corresponds to the scenario defined in the test case, the attack determination unit 522 may continue the subsequent steps, and when all procedures of the scenario are performed, the control plane message including a response and state change information of the control plane received by the scenario performing unit 521 may be analyzed to detect whether there is a security threat including eavesdropping, user privacy, and denial of service.

The foregoing devices may be realized by hardware elements, software elements and/or combinations thereof. For example, the devices and components illustrated in the exemplary embodiments of the inventive concept may be implemented in one or more general-use computers or special-purpose computers, such as a processor, a controller, an arithmetic logic unit (ALU), a digital signal processor, a microcomputer, a field programmable gate array (FPGA), a programmable logic unit (PLU), a microprocessor or any device which may execute instructions and respond. A processing unit may implement an operating system (OS) or one or software applications running on the OS. Further, the processing unit may access, store, manipulate, process and generate data in response to execution of software. It will be understood by those skilled in the art that although a single processing unit may be illustrated for convenience of understanding, the processing unit may include a plurality of processing elements and/or a plurality of types of processing elements. For example, the processing unit may include a plurality of processors or one processor and one controller. Also, the processing unit may have a different processing configuration, such as a parallel processor.

Software may include computer programs, codes, instructions or one or more combinations thereof and may configure a processing unit to operate in a desired manner or may independently or collectively control the processing unit. Software and/or data may be permanently or temporarily embodied in any type of machine, components, physical equipment, virtual equipment, computer storage media or units or transmitted signal waves so as to be interpreted by the processing unit or to provide instructions or data to the processing unit. Software may be dispersed throughout computer systems connected via networks and may be stored or executed in a dispersion manner. Software and data may be recorded in one or more computer-readable storage media.

The methods according to the above-described exemplary embodiments of the inventive concept may be implemented with program instructions which may be executed through various computer means and may be recorded in computer-readable media. The media may also include, alone or in combination with the program instructions, data files, data structures, and the like. The program instructions recorded in the media may be designed and configured specially for the exemplary embodiments of the inventive concept or be known and available to those skilled in computer software. Computer-readable media include magnetic media such as hard disks, floppy disks, and magnetic tape; optical media such as compact disc-read only memory (CD-ROM) disks and digital versatile discs (DVDs); magneto-optical media such as floptical disks; and hardware devices that are specially configured to store and perform program instructions, such as read-only memory (ROM), random access memory (RAM), flash memory, and the like. Program instructions include both machine codes, such as produced by a compiler, and higher level codes that may be executed by the computer using an interpreter. The described hardware devices may be configured to act as one or more software modules to perform the operations of the above-described exemplary embodiments of the inventive concept, or vice versa.

According to the embodiments of the inventive concept, it is possible to dynamically detect a part that may be vulnerable to a man-in-the-middle attack during various implementation or operation policy settings of user equipment and a network in a control plane protocol communication process.

In the case of security analysis of an existing mobile communication network, although most were performed through passive analysis of mobile communication security experts, by utilizing the automated dynamic security analysis technology according to an embodiment of the inventive concept, it is possible to more quickly and accurately find all security threats of man-in-the-middle attacks. Furthermore, the test case generation method of the inventive concept may check various types of vulnerabilities in the man-in-the-middle attack scheme according to the generation rule.

While a few exemplary embodiments have been shown and described with reference to the accompanying drawings, it will be apparent to those skilled in the art that various modifications and variations can be made from the foregoing descriptions. For example, adequate effects may be achieved even if the foregoing processes and methods are carried out in different order than described above, and/or the aforementioned elements, such as systems, structures, devices, or circuits, are combined or coupled in different forms and modes than as described above or be substituted or switched with other components or equivalents.

Thus, it is intended that the inventive concept covers other realizations and other embodiments of this inventive concept provided they come within the scope of the appended claims and their equivalents.

What is claimed is:

1. A method of validating a man-in-the-middle attack on a cellular control plane protocol, the method comprising:
generating a test case defining an operation of the control plane protocol;
performing a man-in-the-middle attack scenario by the test case in conjunction with mobile communication equipment and user equipment by using the test case; and
determining whether there is a security threat to the user equipment or a network by analyzing a control plane message generated by performing the scenario of the test case.

2. The method of claim 1, wherein the generating of the test case includes generating the test case defining a procedure and the operation of the control plane protocol according to each implementation and operation policy, and
wherein the test case includes a number, a direction, a name, a transmission scheme and content of a communication message between the user equipment and a base station.

3. The method of claim 1, wherein the performing of the man-in-the-middle attack scenario includes configuring a scenario form of the man-in-the-middle attack by the test case, and executing an initial setting according to an attack environment of the test case.

4. The method of claim 3, wherein the performing of the man-in-the-middle attack scenario includes performing an operation defined in each step of the test case for each message received from the user equipment or the network when the test case is executed, and determining whether the message received from the user equipment or the network corresponds to the scenario defined in the test case.

5. The method of claim 4, wherein the determining of the security threat includes continuing to a next step when the message corresponds to the scenario defined in the test case, and analyzing the security threat when all the procedures of the scenario are completed.

6. The method of claim 4, wherein the determining of the security threat includes determining that implementation and setting of the user equipment or network are not vulnerable to the man-in-the-middle attack to be tested when the message does not correspond to the scenario defined in the test case.

7. The method of claim 5, wherein the determining of the security threat includes analyzing the control plane message including a response and state change information of the control plane received in the performing of the man-in-the-middle attack scenario to detect whether there is the security threat including eavesdropping, user privacy, and denial of service when all procedures of the scenario are performed through the performing of the man-in-the-middle attack scenario.

8. A system of validating a man-in-the-middle attack on a cellular control plane protocol, the system comprising:
a generation unit configured to generate a test case defining an operation of the control plane protocol; and
an attack detection unit configured to determine whether there is a security threat to user equipment or a network by analyzing a control plane message generated by performing a man-in-the-middle attack scenario by the test case in conjunction with mobile communication equipment and the user equipment by using the test case.

9. The system of claim 8, wherein the generation unit generates the test case defining a procedure and the operation of the control plane protocol according to each implementation and operation policy, and
wherein the test case includes a number, a direction, a name, a transmission scheme and content of a communication message between the user equipment and a base station.

10. The system of claim 8, wherein the attack detection unit includes a scenario performing unit configured to perform the man-in-the-middle attack scenario; and
an attack determination unit configured to determine whether the security threat exists,
wherein the scenario performing unit configures a scenario form of the man-in-the-middle attack by the test case and executes an initial setting according to an attack environment of the test case.

11. The system of claim 10, wherein the scenario performing unit performs an operation defined in each step of the test case for each message received from the user equipment or the network when the test case is executed, and determines whether the message received from the user equipment or the network corresponds to the scenario defined in the test case.

12. The system of claim 11, wherein the attack detection unit continues to a next step when the message corresponds to the scenario defined in the test case, and analyzes the security threat when all the procedures of the scenario are completed.

13. The system of claim 11, wherein the attack detection unit determines that implementation and setting of the user equipment or network are not vulnerable to the man-in-the-middle attack to be tested when the message does not correspond to the scenario defined in the test case.

14. The system of claim 12, wherein the attack detection unit analyzes the control plane message including a response and state change information of the control plane received in the scenario performing unit to detect whether there is the security threat including eavesdropping, user privacy, and denial of service when all procedures of the scenario are performed through the scenario performing unit.
